(19) United States
(12) Patent Application Publication
(10) Pub. No.: US 2017/0031959 A1
(43) Pub. Date: Feb. 2, 2017

(54) SCHEDULING DATABASE COMPACTION IN IP DRIVES

(71) Applicant: KABUSHIKI KAISHA TOSHIBA, Tokyo (JP)

(72) Inventors: Fernando A. ZAYAS, Rangiora (NZ); Richard M. EHRLICH, Saratoga, CA (US)

(21) Appl. No.: 14/814,380

(22) Filed: Jul. 30, 2015

(51) Int. Cl. G06F 17/30; G06F 3/06

(52) U.S. Cl. CPC G06F 17/30303; G06F 3/0631; G06F 3/0643; G06F 3/0685; G06F 17/30371; G06F 17/30117; G06F 17/30138

(57) ABSTRACT

A data storage device that may be employed in a distributed data storage system is configured to track the generation of obsolete data in the storage device and perform a compaction process based on the tracking. The storage device may be configured to track the total number of IOs that result in obsolete data, and, when the total number of such IOs exceeds a predetermined threshold, to perform a compaction process on some or all of the nonvolatile storage media of the storage device. The storage device may be configured to track the total quantity of obsolete data stored by the storage device as the obsolete data are generated, and, when the total quantity of obsolete data exceeds a predetermined threshold, to perform a compaction process on some or all of the nonvolatile storage media of the storage device. The compaction process may occur during a predicted low-utilization period.

### BACKGROUND

The use of distributed computing systems, e.g., “cloud computing,” is becoming increasingly common for consumer and enterprise data storage. This so-called “cloud data storage” employs large numbers of networked storage servers that are organized as a unified repository for data, and are configured as banks or arrays of hard disk drives, central processing units, and solid-state drives. These servers may be arranged in high-density configurations to facilitate such large-scale operation. For example, a single cloud data storage system may include thousands or tens of thousands of storage servers installed in stacked or rack-mounted arrays.

For reduced latency in such distributed computing systems, object-oriented database management systems using “key-value pairs” are typically employed, rather than relational database systems. A key-value pair is a set of two linked data items: a key, which is a unique identifier for some set of data, and a value, which is the set of data associated with the key. Distributed computing systems using key-value pairs provide a high performance alternative to relational database systems.

In some implementations of cloud computing data systems, however, obsolete data, i.e., data stored on a storage server for which a more recent copy is also stored, can accumulate quickly. The presence of obsolete data on the nonvolatile storage media of a storage server can greatly reduce the capacity of the storage server. Consequently, obsolete data is periodically removed from such storage servers via compaction, a process that can be computationally expensive and, while being executed, can increase the latency of the storage server.

### SUMMARY

One or more embodiments provide a data storage device that may be employed in a distributed data storage system. According to some embodiments, the storage device is configured to track the generation of obsolete data in the storage device and, perform a compaction process based on the tracking. In one embodiment, the storage device is configured to track the total number of input-output operations (IOs) that result in obsolete data on an IP drive, such as certain PUT and DELETE commands received from a host. When the total number of such IOs exceeds a predetermined threshold, the storage device may perform a compaction process on some or all of the nonvolatile storage media of the storage device. In another embodiment, the storage device is configured to track the total quantity of obsolete data stored in the storage device as the obsolete data are generated, such as when certain PUT and DELETE commands are received from a host. When the total quantity of obsolete data exceeds a predetermined threshold, the storage device may perform a compaction process on some or all of the nonvolatile storage media of the storage device.

A data storage device, according to an embodiment, includes a storage device in which data are stored as key-value pairs, and a controller. The controller is configured to determine for a key that is designated in a command received by the storage device whether or not the key has a corresponding value that is already stored in the storage device and, if so, to increase a total size of obsolete data in the storage device by the size of the corresponding value that has most recently been stored in the storage device, wherein the controller performs a compaction process on the storage device based on the total size of the obsolete data.

A data storage system, according to an embodiment, includes a storage device in which data are stored as key-value pairs, and a controller. The controller is configured to receive a key that is designated in a command received by the storage device, determine for the received key whether or not the key has a corresponding value that is already stored in the storage device, in response to the key having the corresponding value, increment a counter, and in response to the counter exceeding a predetermined threshold, perform a compaction process on the storage device.

### BRIEF DESCRIPTION OF THE DRAWINGS

FIG. 1 is a block diagram of a distributed storage system, configured according to one or more embodiments.

FIG. 2 is a block diagram of a storage drive of the distributed storage system of FIG. 1, configured according to one or more embodiments.

FIG. 3 sets forth a flowchart of method steps carried out by the storage drive of FIG. 2 for performing data compaction, according to one or more embodiments.

FIG. 4 sets forth a flowchart of method steps carried out by the storage drive of FIG. 2 for performing data compaction during a predicted period of low utilization, according to one or more embodiments.

### DETAILED DESCRIPTION

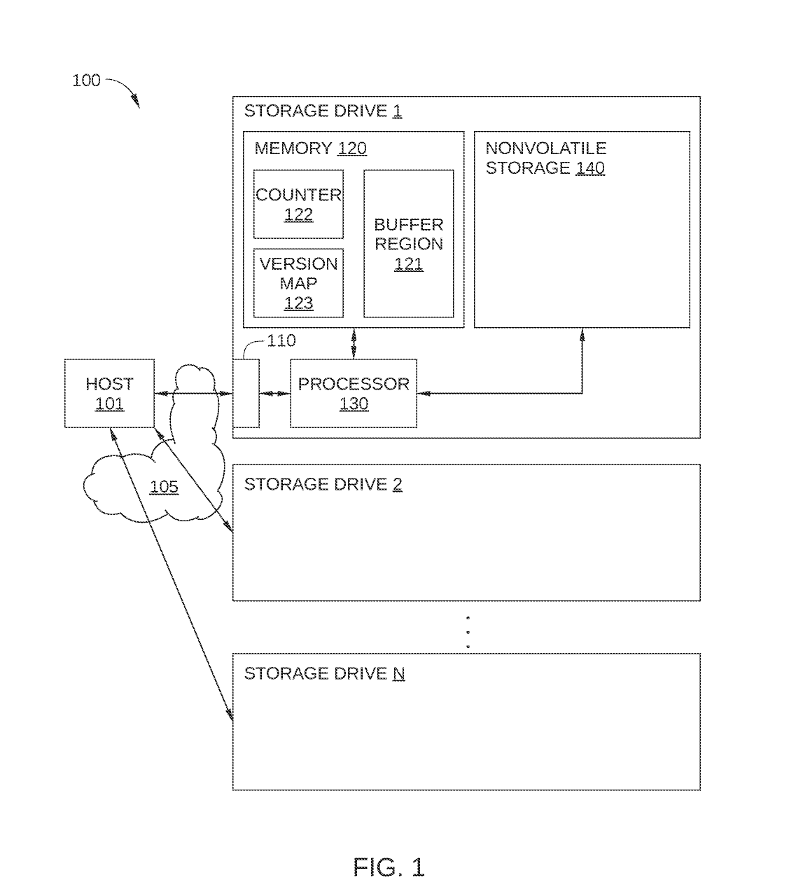

FIG. 1 is a block diagram of a distributed storage system 100, configured according to one or more embodiments. Distributed storage system 100 includes a host 101 connected to a plurality of storage drives 1-N via a network 105. Distributed storage system 100 is configured to facilitate large-scale data storage for a plurality of hosts or users. Distributed storage system 100 may be an object-based storage system, which organizes data into flexible-sized data units of storage called “objects.” These objects generally include a set of data, also referred to as a “value,” and an identifier, sometimes referred to as a “key”, which together form a “key-value pair.” In addition to the key and value, such objects may include other attributes or metadata, for example, a version number and data integrity checks of the value portion of the object. The key or other identifier facilitates storage, retrieval, and other manipulation of the associated value by host 101 without host 101 providing information regarding the specific physical storage location or locations of the object in distributed storage system 100 (such as specific location in a particular storage device). This approach simplifies and streamlines data storage in cloud computing, since host 101, or a plurality of hosts (not shown), can make data storage requests directly to a particular one of storage drives 1-N without consulting a large data structure describing the entire addressable space of distributed storage system 100.

Host 101 may be a computing device or other entity that requests data storage services from storage drives 1-N. For example, host 101 may be a web-based application or any other technically feasible storage client. Host 101 may also be configured with software or firmware suitable to facilitate transmission of objects, such as key-value pairs, to one or more of storage drives 1-N for storage of the object therein. For example, host 101 may perform PUT, GET, and DELETE operations utilizing object-based scale-out protocol to request that a particular object be stored on, retrieved from, or removed from one or more of storage drives 1-N. While a single host 101 is illustrated in FIG. 1, a plurality of hosts substantially similar to host 101 may each be connected to storage drives 1-N.

In some embodiments, host 101 may be configured to generate a set of attributes or a unique identifier, such as a key, for each object that host 101 requests to be stored in storage drives 1-N. In some embodiments, host 101 may generate each key or other identifier for an object based on a universally unique identifier (UUID), to prevent two different hosts from generating identical identifiers. Furthermore, to facilitate substantially uniform use of storage drives 1-N, host 101 may generate keys algorithmically for each object to be stored in distributed storage system 100. For example, a range of key values available to host 101 may be distributed uniformly between a list of storage drives 1-N that are currently included in distributed storage system 100.

Storage drive 1, and some or all of storage drives 2-N, may each be configured to provide data storage capacity as one of a plurality of object servers of distributed storage system 100. To that end, storage drive 1 (and some or all of storage drives 2-N) may include one or more network connections 110, a memory 120, a processor 130, and a nonvolatile storage 140. Network connection 110 enables the connection of storage drive 1 to network 105, which may be any technically feasible type of communications network that allows data to be exchanged between host 101 and storage drives 1-N, such as a wide area network (WAN), a local area network (LAN), a wireless (WiFi) network, and/or the Internet, among others. Network connection 110 may include a network controller, such as an Ethernet controller, which controls network communications from and to storage drive 1.

Memory 120 may include one or more solid-state memory devices or chips, such as an array of volatile random-access memory (RAM) chips. During operation, memory 120 may include a buffer region 121, a counter 122, and in some embodiments a version map 123. Buffer region 121 is configured to store key-value pairs received from host 101, in particular the key-value pairs most recently received from host 101. Counter 122 stores a value for tracking generation of obsolete data in storage drive 1, such as the total quantity of obsolete data currently stored in storage drive 1 or the total number of inputs (or IOs) from host 101 causing data stored in storage drive 1 to become obsolete. Version map 123 stores, for each key-value pair stored in storage drive 1, the most recent version for that key-value pair.

Processor 130 may be any suitable processor implemented as a single core or multi-core central processing unit (CPU), a graphics processing unit (GPU), an application-specific integrated circuit (ASIC), a field programmable gate array (FPGA), or another type of processing unit. Processor 130 may be configured to execute program instructions associated with the operation of storage drive 1 as an object server of distributed storage system 100, including receiving data from and transmitting data to host 101, collecting groups of key-value pairs into files, and tracking when such files are written to nonvolatile storage 140. In some embodiments, processor 130 may be shared for use by other functions of the storage drive 1, such as managing the mechanical functions of a rotating media drive or the data storage functions of a solid-state drive. In some embodiments, processor 130 and one or more other elements of storage device 1 may be formed as a single chip, such as a system-on-chip (SOC), including bus controllers, a DDR controller for memory 130, and/or the network controller of network connection 110.

Nonvolatile storage 140 is configured to store key-value pairs received from host 101, and may include one or more hard disk drives (HDDs) or other rotating media and/or one or more solid-state drives (SSDs) or other solid-state nonvolatile storage media. In some embodiments, nonvolatile storage 140 is configured to store a group of key-value pairs as a single data file. Alternatively, nonvolatile storage 140 may be configured to store each of the key-value pairs received from host 101 as a separate file.

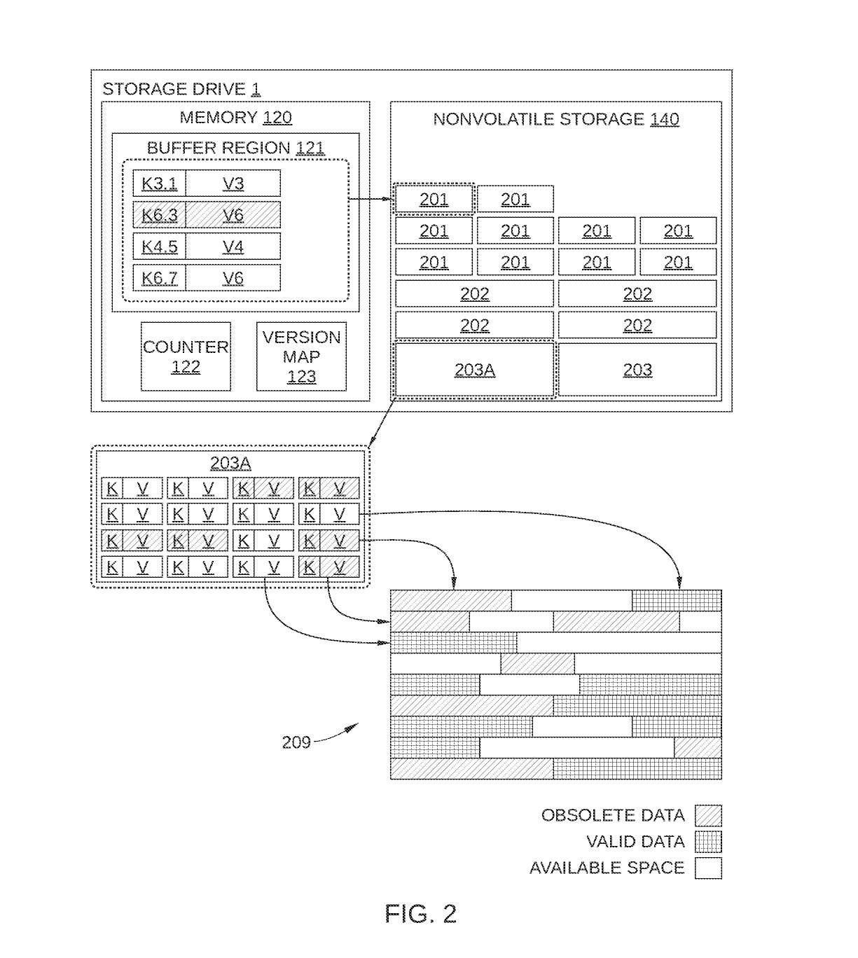

In operation, storage drive 1 receives and executes PUT, GET, and DELETE commands from host 101. PUT commands indicate a request from host 101 for storage drive 1 to store the key-value pair associated with the PUT command. GET commands indicate a request from host 101 for storage drive 1 to retrieve the value, i.e., the data, associated with a key included in the GET command. DELETE commands indicate a request from host 101 for storage drive 1 to delete from storage the key-value pair included in the DELETE command. Generally, PUT and DELETE commands received from host 101 cause valid data currently stored in nonvolatile storage 140 to become obsolete data, which reduce the available storage capacity of storage drive 1. According to some embodiments, storage drive 1 tracks the generation of obsolete data that result from PUT and DELETE commands, and based on the tracking, performs a compaction process to remove some or all of the obsolete data stored therein. One such embodiment is described below in conjunction with FIG. 2.

FIG. 2 is a block diagram of storage drive 1, configured according to one or more embodiments. In the embodiment illustrated in FIG. 2, storage drive 1 includes network connection 110, memory 120, processor 130, and nonvolatile storage 140, as described above. For clarity, network connection 110 and processor 130 are omitted in FIG. 2. In the embodiment illustrated in FIG. 2, buffer region 121 stores key-value pair 3, key-value pair 4, and two versions of key-value pair 6. These key-value pairs are the key-value pairs that have been most recently received by storage drive 1, for example in response to PUT commands issued by host 101. Thus, when storage drive 1 receives a PUT command from host 101 or any other source, storage drive 1 stores the key-value pair associated with the PUT command in buffer region 121.

Key-value pair 3 includes a key 3.1 (i.e., version 1 of key number 3) and a corresponding value 3; key-value pair 4 includes a key 4.5 (i.e., version 5 of key number 4) and a corresponding value 4; one version of key-value pair 6 includes a key 6.3 (i.e., version 3 of key number 6) and a corresponding value 6; and a second version of key-value pair 6 includes a key 6.7 (i.e., version 7 of key number 6) and a corresponding value 6. Because key 6.3 is an earlier version than key 6.7, key 6.3 and the value 6 associated therewith are obsolete data (designated by diagonal hatching). Consequently, when storage drive 1 receives a GET command for the value 6, i.e., a GET command that includes key 6.7, storage drive 1 will return the value 6 associated with key 6.7 and not the value 6 associated with key 6.3, which is obsolete. It is noted that the term “version,” as used herein, may refer to an explicit version indicator associated with a specific key, or may be any other unique identifying information or metadata associated with a specific key, such as a timestamp, etc.

In operation, when the storage capacity of buffer region 121 is filled or substantially filled, storage drive 1 combines the contents of buffer region 121 into a single file, and stores the file as a first-tier file 201 in nonvolatile storage 140. As shown, nonvolatile storage 140 stores a plurality of files, including first-tier files 201, second-tier files 202, and third-tier files 203. In the embodiment illustrated herein, first-tier files 201, second-tier files 202, and third-tier files 203 are stored in non-volatile storage 140. Alternatively, they may be stored in different units of non-volatile storage 140 or different forms of non-volatile storage 140, e.g., first-tier files 201 being stored in solid state storage while second-tier files 202 and third-tier files 203 being stored in rotating media storage.

First-tier files 201 each include key-value pairs that have been combined from buffer region 121. Second-tier files 202 are generally formed when storage drive 1 combines the contents of multiple first-tier files 201 after these particular first-tier files 201 have been stored in nonvolatile storage 140 for a specific time period. Second-tier files 202 may be employed for “cool” or “cold” storage of key-value pairs, since the key-value pairs included in second-tier files 202 have been stored in storage drive 1 for a longer time than the key-value pairs stored in first-tier files 201. Similarly, third-tier files 203 are generally formed when storage drive 1 combines the contents of multiple second-tier files 202 after these particular second-tier files 202 have been stored in nonvolatile storage 140 for a specific time period. Thus, third-tier files 203 may be employed for “cold” storage of key-value pairs that have been stored in storage drive 1 for a time period longer than key-value pairs stored in first-tier files 201 or second-tier files 202.

In some embodiments, first-tier files 201 in nonvolatile storage 140 are organized based on the order in which first-tier files 201 are created by storage drive 1. For example, a particular first-tier file 201 may include metadata indicating the time of creation of that particular first-tier file 201. Similarly, second-tier files 202 and third-tier files 203 may also be organized based on the order in which second-tier files 202 and third-tier files 203 are created by storage drive 1.

In some embodiments, a compaction and/or compression process is performed on the key-value pairs of first-tier files 201 before these first-tier files 201 are combined into second-tier files 202. Alternatively or additionally, a compaction and/or compression process is performed on the key-value pairs of second-tier files 202 before these second-tier files 202 are combined into third-tier files 203. Generally, a compaction process employed in storage drive 1 includes searching for duplicates of a particular key in nonvolatile storage 140, and removing the older versions of the key and values associated with the older versions of the key. In this way, storage space in nonvolatile storage 140 that is used to store obsolete data is made available to again store valid data.

In distributed storage system 100, large numbers of key-value pairs may be continuously written to storage drive 1, many of which are newer versions of key-value pairs already stored in storage drive 1. To reduce latency, older versions of key-value pairs are typically retained in nonvolatile storage 140 when a PUT command results in a newer version of the key-value pair being stored in nonvolatile storage 140. Consequently, obsolete data, such as the many older versions of key-value pairs, can quickly accumulate in nonvolatile storage 140 during normal operation of distributed storage drive 1, as illustrated in an example third-tier file 203A.

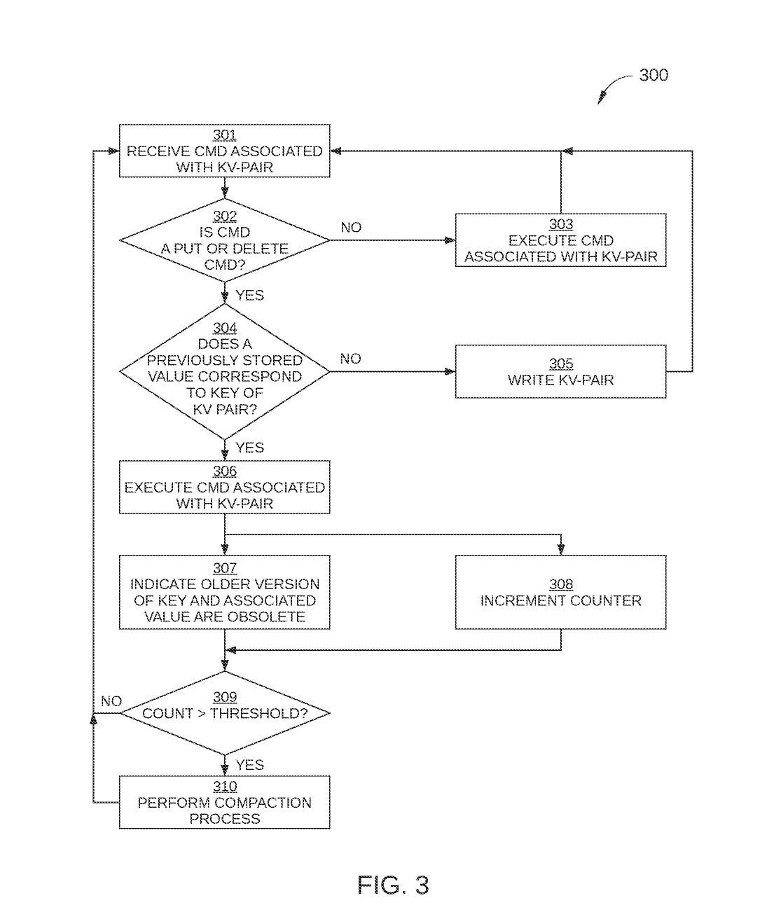

Example third-tier file 203A includes a combination of obsolete key-value pairs (diagonal hatching) and valid key-value pairs. Both the valid and obsolete key-value pairs included in example third-tier file 203A are mapped to respective physical locations in a storage medium 209 associated with nonvolatile storage 140. Even though the values of obsolete key-value pairs cannot be read or used by host 101, the accumulation of obsolete key-value pairs in nonvolatile storage 140 reduces the available space on storage medium 209 for storing additional data. Thus, the removal of obsolete key-value pairs, for example via a compaction process, is highly desirable. According to some embodiments, storage drive 1 is configured to track the generation of obsolete data in nonvolatile storage 140, and to perform a compaction process based on the tracking. One such embodiment is described below in conjunction with FIG. 3.

FIG. 3 sets forth a flowchart of method steps carried out by storage drive 1 for performing data compaction, according to one or more embodiments. Although the method steps are described in conjunction with distributed storage system 100 of FIG. 1, persons skilled in the art will understand that the method in FIG. 3 may also be performed with other types of computing systems. The control algorithms for the method steps may reside in and/or be performed by processor 130, host 101, and/or any other suitable control circuit or system.

As shown, a method 300 begins at step 301, where storage drive 1 receives a command associated with a particular key-value pair from host 101. For example, the command may be a PUT, GET, or DELETE command, and may reference a particular key-value pair of interest. In step 302, storage drive 1 determines whether the command received in step 301 is a PUT or DELETE command or some other command, such as a GET command. If the command is either a PUT or DELETE command, method 300 proceeds to step 304; if the command is some other command, method 300 proceeds to step 303. In step 303, storage drive 1 executes the command received in step 301.

In step 304, storage drive 1 determines whether a previously stored value corresponds to the “target key,” i.e., the key of the key-value pair associated with the command received in step 301. To that end, in some embodiments, storage drive 1 searches memory 120 and nonvolatile storage 140 for the most recently stored previous version of the target key and, if no previous version of the target key is found, method 300 proceeds to step 305. In embodiments in which the command is a DELETE command and the target key designated in the command is not found, a NOT FOUND reply may be generated in step 304. If storage drive 1 finds a previous version of the target key, method 300 proceeds to step 306. In such embodiments, storage drive 1 may first search memory 120, since the key-value pairs most recently received by storage drive 1 are stored therein. Storage drive 1 may then search nonvolatile storage 140, starting with first-tier files 201, in reverse order of creation, then second-tier files 202, in reverse order of creation, then third-tier files 203, in reverse order of creation. Alternatively, in some embodiments, storage drive 1 may determine whether a previously stored value corresponding to the target key is stored in storage drive 1 by consulting version map 123, which tracks the most recent version of each key-value pair stored in storage drive 1.

In step 305, which is performed in response to storage drive 1 determining that there is no previously stored value corresponding to the target key, storage drive 1 executes the command received in step 301. It is noted that because there is no previously stored value corresponding to the target key, the command received in step 301 cannot be a DELETE command, which by definition references a previously stored key-value pair. Thus, in step 305, the command is a PUT command. Accordingly, storage drive 1 executes the PUT command by storing the key-value pair associated with the PUT command in buffer region 121.

In step 306, which is performed in response to storage drive 1 determining that there is a previously stored value corresponding to the target key, storage drive 1 executes the command received in step 301. The command may be a PUT or DELETE command. When the command is a DELETE command, a key-value pair that indicates “key deleted” may be stored as the most recent state of the target key. In step 307, storage drive 1 indicates that the most recently stored previous version of the target key (found in step 304) and the value associated with the previous version of the target key are now obsolete data.

In step 308, storage drive 1 increments counter 122. In embodiments in which storage drive 1 tracks a total number of commands from host 101 that result in obsolete data being generated, counter 122 is incremented by a value of 1. In embodiments in which storage drive 1 tracks a total quantity of obsolete data currently stored in storage drive 1, storage drive 1 increments counter 122 by a value that corresponds to the quantity of data indicated to be obsolete in step 306. For example, when storage drive 1 indicates that a particular key-value pair having a size of 15 MBs is obsolete in step 306, the storage drive 1 increments counter 122 by 15 MBs in step 308.

In step 309, storage drive 1 determines whether counter 122 exceeds a predetermined threshold. The threshold may be a total number of commands from host 101 that result in obsolete data being generated, such as PUT and DELETE commands. Alternatively, the threshold may be a maximum quantity of obsolete data to be stored in storage drive 1, or a maximum portion of the total storage capacity of nonvolatile storage 140. When counter 122 is determined to exceed the predetermined threshold, method 300 proceeds to step 310; when counter 122 does not exceed the threshold, method 300 proceeds back to step 301.

In step 310, storage drive 1 performs a compaction process on some or all of nonvolatile storage 140. In some embodiments, the compaction process is performed on second-tier files 202 and third-tier files 203, but not on first-tier files 201, since first-tier files 201 have generally not been stored for an extended time period and therefore are unlikely to include a high portion of obsolete data. In other embodiments, the compaction process is performed on first-tier files 201 as well. After completion of the compaction process, counter 122 is generally reset.

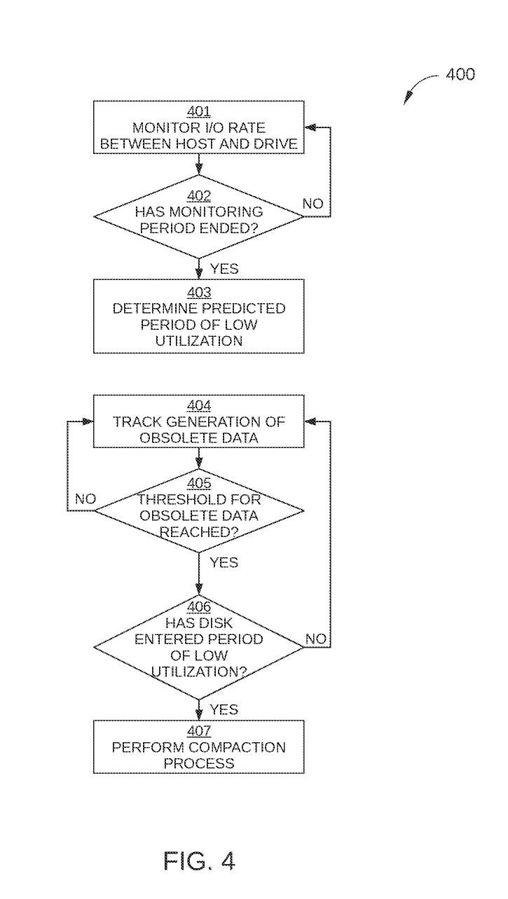

Thus, when method 300 is employed by storage drive 1, a compaction process is performed based on obsolete data stored in storage drive 1, rather than on a predetermined maintenance schedule or other factors. According to some embodiments, storage drive 1 may also be configured to determine a predicted period of low utilization for storage drive 1, and perform the compaction process during the low utilization period. One such embodiment is described below in conjunction with FIG. 4.

FIG. 4 sets forth a flowchart of method steps carried out by storage drive 1 for performing data compaction during a predicted period of low utilization, according to one or more embodiments. Although the method steps are described in conjunction with distributed storage system 100 of FIG. 1, persons skilled in the art will understand that the method in FIG. 4 may also be performed with other types of computing systems. The control algorithms for the method steps may reside in and/or be performed by processor 130, host 101, and/or any other suitable control circuit or system.

As shown, a method 400 begins at step 401, where storage drive 1 monitors an IO rate between storage drive 1 and host 101 or multiple hosts. For example, the IO rate may be based on the number of commands received per unit time by storage drive 1 from host 101, or from the multiple sources, when applicable. Thus, in step 401, storage drive 1 may continuously measure and record the IO rate. In step 402, storage drive 1 determines whether the monitoring period has ended. For example, the monitoring period may extend over multiple days or weeks. If the monitoring period has ended, method 400 proceeds to step 403; if the monitoring period has not ended, method 400 proceeds back to step 401.

In step 403, storage drive 1 determines a predicted period of low utilization for storage drive 1, based on the monitoring performed in step 401. For example, storage drive 1 may determine that a particular time period each day or each week is on average a low-utilization period for storage drive 1. The determination may be based on an average IO rate over many repeating time periods, a running average of multiple recent time periods, and the like.

In step 404, storage drive 1 tracks generation of obsolete data in storage drive 1. In some embodiments, storage drive 1 may employ steps 301-308 of method 300 to track obsolete data generation. Thus, storage drive 1 may track a total quantity of obsolete data currently stored in storage drive 1 or a total number of commands received from one or more hosts that result in the generation of obsolete data in storage drive 1. In step 405, storage drive 1 determines whether a predetermined threshold is exceeded, either for total obsolete data stored in storage drive 1 or for total commands received that result in the generation of obsolete data in storage drive 1. If the threshold is exceeded, method 400 proceeds to step 406; if not, method 400 proceeds back to step 404.

In step 406, storage drive 1 determines whether storage drive 1 has entered the period of low utilization (as predicted in step 403). If yes, method 400 proceeds to step 407; if no, method 400 proceeds back to step 404. In step 407, storage drive 1 performs a compaction process on some or all of the key-value pairs stored in storage drive 1. Any technically feasible compaction algorithm known in the art may be employed in step 407. In some embodiments, the compaction process is performed on second-tier files 202 and third-tier files 203 in step 407, but not on first-tier files 201, since first-tier files 201 have generally not been stored for an extended time period and therefore are unlikely to include a high portion of obsolete data. In other embodiments, the compaction process is performed on first-tier files 201 as well.

Thus, when method 400 is employed by storage drive 1, a compaction process is performed based on tracked obsolete data stored in storage drive 1 and on the predicted utilization of storage drive 1. In this way, impact on performance of storage drive 1 is minimized or otherwise reduced, since computationally expensive compaction processes are performed when there is a demonstrated need, and at a time when utilization of storage drive 1 is likely to be low.

While the foregoing is directed to embodiments of the present invention, other and further embodiments of the invention may be devised without departing from the basic scope thereof, and the scope thereof is determined by the claims that follow.

We claim:

1. A data storage device comprising
a storage device in which data are stored as key-value pairs; and
a controller configured to determine for a key that is designated in a command received by the storage device whether or not the key has a corresponding value that is already stored in the storage device and, if so, to increase a total size of obsolete data in the storage device by the size of the corresponding value that has most recently been stored in the storage device,
wherein the controller performs a compaction process on the storage device based on the total size of the obsolete data.

2. The data storage device of claim 1, wherein the controller performs the compaction process on the storage device based on a combination of the total size of the obsolete data and an additional factor.

3. The data storage device of claim 2, wherein the additional factor includes at least one of a ratio of the total size of obsolete data to a total storage capacity of the storage device exceeding a predetermined threshold, a predicted low utilization period beginning, or a combination of both.

4. The data storage device of claim 3, wherein the controller is further configured to:
monitor an IO rate between the storage device and a host for a particular time period; and
based on the monitored IO rate, determine the predicted period of low utilization.

5. The data storage device of claim 1, wherein the controller is further configured to store the key and an associated value that is also designated in the command in the storage device, and wherein the compaction process comprises deleting the corresponding value that is already stored in the device.

6. The data storage device of claim 1, wherein the controller is further configured to perform the compaction process by deleting at least a portion of the obsolete data.

7. The data storage device of claim 6, wherein the portion of the obsolete data is associated with a first group of files stored in the storage device and the controller is further configured to perform the compaction process by:
deleting the portion of the obsolete data; and
retaining another portion of the obsolete data that is associated with a second group of files stored in the storage device.

8. The data storage device of claim 7, wherein the first group of files includes key-value pairs that have been updated more recently than any key-value pairs that are included in the second group of files.

9. The data storage device of claim 7, wherein the first group of files includes no compressed files and the second group of files includes only compressed files.

10. The data storage device of claim 1, further comprising a volatile solid-state memory, and a nonvolatile solid-state memory, wherein the controller is further configured to:
receive the key and an associated value that is also designated in the command in the volatile solid-state memory,
combine the key and the associated value with one or more additional key-value pairs stored in the volatile solid-state memory into a single file, and
store the single file in the nonvolatile solid-state memory.

11. The data storage device of claim 10, wherein the controller is further configured to combine the single file stored in the nonvolatile solid-state memory with one or more additional files stored in the nonvolatile solid-state memory into a higher tier file.

12. The data storage device of claim 1, wherein the command is a command to store a key-value pair in the storage device.

13. The data storage device of claim 1, wherein the command is a command to delete a key-value pair stored in the storage device.

14. A data storage device comprising
a storage device in which data are stored as key-value pairs; and
a controller configured to:
receive a key that is designated in a command received by the storage device,
determine for the received key whether or not the key has a corresponding value that is already stored in the storage device,
in response to the key having the corresponding value, increment a counter, and
in response to the counter exceeding a predetermined threshold, perform a compaction process on the storage device.

15. The data storage device of claim 14, wherein the command is a command to store a key-value pair.

16. The data storage device of claim 14, further comprising a volatile solid-state memory, and a nonvolatile solid-state memory, wherein the controller is further configured to:
receive the key and an associated value that is also designated in the command in the volatile solid-state memory,
combine the key and the associated value that is also designated in the command with one or more additional key-value pairs stored in the volatile solid-state memory into a single file, and
store the single file in the nonvolatile solid-state memory.

17. The data storage device of claim 16, wherein the controller is further configured to combine the single file stored in the nonvolatile solid-state memory with one or more additional files stored in the nonvolatile solid-state memory into a higher tier file.

18. The data storage device of claim 17, wherein the controller is further configured to store the higher tier file on the hard disk drive.

19. The data storage device of claim 18, wherein the controller is further configured to compress the higher tier file prior to storing the higher tier file on the hard disk drive.

20. A method of storing data in a data storage device, the method comprising:
receiving a key that is designated in a command received by the storage device,
determining for the received key whether or not the key has a corresponding value that is already stored in the storage device,
in response to determining that the key has the corresponding value, updating a tracking variable for the obsolete data, and
performing a compaction process on the storage device based on the tracking variable.
